(19) United States
(12) Patent Application Publication
(10) Pub. No.: US 2024/0188103 A1
(43) Pub. Date: Jun. 6, 2024

(54) SIDELINK LOGICAL CHANNEL PRIORITIZATION

(71) Applicant: Lenovo (Singapore) Pte. Ltd., New Tech Park (SG)

(72) Inventors: Joachim Löhr, Wiesbaden (DE); Prateek Basu Mallick, Dreieich (DE)

(21) Appl. No.: 18/553,699

(22) PCT Filed: Mar. 29, 2022
(86) PCT No.: PCT/IB2022/052912

§ 371 Date: Oct. 2, 2023

Related U.S. Application Data
(60) Provisional application No. 63/168,185, filed on Mar. 30, 2021.

(51) Int. Cl. H04W 72/25; H04W 72/02; H04W 76/28; H04W 80/02

(52) U.S. Cl. CPC H04W 72/25; H04W 72/02; H04W 76/28; H04W 80/02

(57) ABSTRACT

Apparatuses, methods, and systems are disclosed for sidelink logical channel prioritization. An apparatus (400) includes a processor (405) that determines a sidelink (“SL”) grant for a new SL transmission and selects a destination for the new SL transmission allocated by the SL grant based on at least one of a set of SL logical channels (“LCHs”) and a set of 5 medium access control (“MAC”) control elements (“CEs”) wherein the selected destination is in a SL active time for a SL transmission occasion allocated by the SL grant for the new SL transmission.

### CROSS-REFERENCE TO RELATED APPLICATIONS

This application claims the benefit of U.S. Provisional Patent Application No. 63/168,185, entitled “EFFICIENT SIDELINK LOGICAL CHANNEL PRIORITIZATION PROCEDURE CONSIDERING DRX” and filed on Mar. 30, 2021, for Joachim Löhr, et al., which is incorporated herein by reference.

### FIELD

The subject matter disclosed herein relates generally to wireless communications and more particularly relates to sidelink logical channel prioritization.

### BACKGROUND

In wireless networks, sidelink communication can save power by using discontinuous reception (“DRX”)/discontinuous transmission (“DTX”) configuration. If the DRX/DTX configurations are based on quality of service (“QoS”), the DRX configurations can be different among the logical channels. The logical channels may belong to more than one sidelink destination and since, for a transmission, a medium access control (“MAC”) packet data unit (“PDU”) is prepared only towards one destination, a proper resource allocation to maximize power saving as well as resource usage needs to be designed.

### BRIEF SUMMARY

Disclosed are solutions for sidelink logical channel prioritization. The solutions may be implemented by apparatus, systems, methods, or computer program products.

A first apparatus includes a processor that determines a sidelink (“SL”) grant for a new SL transmission and selects a destination for the new SL transmission allocated by the SL grant based on at least one of a set of SL logical channels (“LCHs”) and a set of medium access control (“MAC”) control elements (“CEs”). In one embodiment, the selected destination is in a SL active time for a SL transmission occasion allocated by the SL grant for the new SL transmission.

A first method determines a sidelink (“SL”) grant for a new SL transmission and selects a destination for the new SL transmission allocated by the SL grant based on at least one of a set of SL logical channels (“LCHs”) and a set of medium access control (“MAC”) control elements (“CEs”). In one embodiment, the selected destination is in a SL active time for a SL transmission occasion allocated by the SL grant for the new SL transmission.

A second apparatus includes a processor that applies discontinuous reception (“DRX”) for sidelink (“SL”) transmission with a user equipment (“UE”) and enables an SL active time state for the SL transmission over an SL logical channel (“LCH”). In one embodiment, the second apparatus includes a transceiver that receives the SL transmission from the transmitting UE over the SL LCH in response to applying DRX and enabling the SL active time state.

A second method applies discontinuous reception (“DRX”) for sidelink (“SL”) transmission with a user equipment (“UE”), enables an SL active time state for the SL transmission over an SL logical channel (“LCH”), and receives the SL transmission from the transmitting UE over the SL LCH in response to applying DRX and enabling the SL active time state.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for sidelink logical channel prioritization;

FIG. 2 is a flowchart depicting the UE behaviour as well as SL logical channel prioritization procedure;

FIG. 3 is a diagram illustrating one embodiment of a NR protocol stack;

FIG. 4 is a block diagram illustrating one embodiment of a user equipment apparatus that may be used for sidelink logical channel prioritization;

FIG. 5 is a block diagram illustrating one embodiment of a network apparatus that may be used for sidelink logical channel prioritization; and

FIG. 6 is a schematic flow chart diagram illustrating one embodiment of a method for sidelink logical channel prioritization.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for sidelink logical channel prioritization. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In wireless networks, sidelink communication can save power by using DRX/DTX configuration. If these DRX/DTX configurations are based on QoS (e.g., PC5 QoS Identifier (“PQI”) for sidelink (“SL”)), the DRX configurations can be different among the logical channels. These logical channels may belong to more than one sidelink destination and since for a transmission a MAC PDU is prepared only towards one destination, a proper resource allocation to maximize power saving as well as resource usage needs to be designed.

For cases when a SL transmitting user equipment (“UE”) doesn't consider the DRX configuration(s) applied between the Tx UE and the corresponding Rx UE(s) during the SL logical channel prioritization procedure, it may be that the corresponding Rx UE(s) are not in active time, e.g., are not monitoring physical sidelink share channel (“PSSCH”)/physical sidelink control channel (“PSCCH”) and ready to receive a SL data transmission. In order to avoid the situation that a SL transmission cannot be received by Rx UE(s) due to the fact that the Rx UE(s) are not awake and monitoring for PSCCH/PSSCH, the behavior during sidelink logical channel prioritization procedure is to be specified. It should be noted that the problem described above has not been addressed in third generation partnership project (“3GPP”) RAN2 contributions/meetings, therefore there is no existing solution.

One solution includes aligning with the current Rel. 16 behavior but starts with first shortlisting the logical channels that have corresponding recipients in active time for a given grant. Thereafter, the Rel. 16 based destination selection and logical channel prioritization procedure takes over for the qualifying destination all logical channels (“LCHs”) with data may be accounted or alternatively, only data from the shortlisted LCHs.

In another approach, the destination selection is the same as in Rel. 16 e.g., a destination with the highest logical channel priority is selected. Thereafter, for the selected destination, those logical channels that have corresponding recipients in active time are selected. If there's no such logical channel, the first step (e.g., destination selection) is run again but without considering the logical channels of the first destination. Other approaches are also defined that are further optimizations of these two main solutions.

According to a first embodiment, a Tx UE considers those SL LCH(s) for the selection of the destination where the corresponding DRX active time matches with the allocated SL resources, e.g., SL resources allocated by a gNB or SL resources selected autonomously by the Tx UE (e.g., mode 2) that are within the DRX active time of the SL LCH(s) respectively the DRX active time of the associated destination. For mode 1, for example, if the UE has SL data of SL LCH x in its buffer when SL grant is received and the DRX active time associated with SL LCH x doesn't overlap with the SL resources (allocated by SL grant), e.g., SL LCH x is not in active time in the slot where SL resources are allocated, the UE shall not consider SL LCH x for the selection of the SL destination and/or the sidelink logical channel prioritization procedure.

According to another embodiment, the Tx UE considers those SL LCH(s) for the selection of the destination and allocation of sidelink resources during the sidelink logical channel prioritization procedure whose corresponding DRX configuration is in active time for the allocated SL resources. According to one implementation of the embodiment, a SL logical channel mapping restriction is introduced which is to be considered for the selection of the destination and the allocation of sidelink resources during the SL logical channel prioritization procedure.

Conventional solutions either do not take the DRX configurations into account or do not describe sidelink destination selection and logical channel/resource selection procedures that also considers QoS/PQI/priority-based DRX configurations.

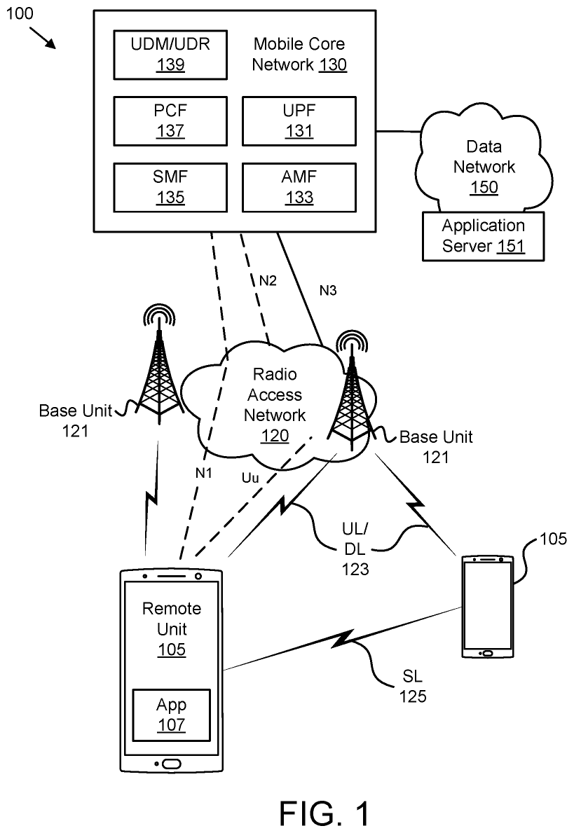

FIG. 1 depicts a wireless communication system 100 supporting sidelink logical channel prioritization, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) 136, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (DN), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

As background, regarding DRX, e.g., as described in TS38.321, a MAC entity may be configured by radio resource control (“RRC”) with a DRX functionality that controls the UE's physical downlink control channel (“PDCCH”) monitoring activity for the MAC entity's cell radio network temporary identifier (“C-RNTI”), cancellation indication (“CI”)-RNTI, configured scheduling (“CS”)-RNTI, interruption (“INT”)-RNTI, slot format indication (“SFI”)-RNTI, semi-persistent (“SP”)-channel state information (“CSI”)-RNTI, transmit power control (“TPC”)-physical uplink control channel (“PUCCH”)-RNTI, TPC-physical uplink shared channel (“PUSCH”)-RNTI, and TPC-sounding reference signal (“SRS”)-RNTI. When using DRX operation, the MAC entity shall also monitor PDCCH according to requirements found in other clauses of this specification. When in RRC_CONNECTED, if DRX is configured, for all the activated serving cells, the MAC entity may monitor the PDCCH discontinuously using the DRX operation; otherwise the MAC entity may monitor the PDCCH as specified in TS 38.213.

In one embodiment, RRC controls DRX operation by configuring the following parameters:
drx-onDurationTimer: the duration at the beginning of a DRX Cycle;
drx-SlotOffset: the delay before starting the drx-onDurationTimer;
drx-InactivityTimer: the duration after the PDCCH occasion in which a PDCCH indicates a new UL or DL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX Cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
ps-Wakeup (optional): the configuration to start associated drx-onDurationTimer in case DCP (DCI with CRC scrambled by power saving (“PS”)-RNTI) is monitored but not detected;
ps-Periodic_CSI_Transmit (optional): the configuration to report periodic CSI during the time duration indicated by drx-onDurationTimer in case DCP is configured but associated drx-onDurationTimer is not started;
ps-TransmitPeriodicL1-RSRP (optional): the configuration to transmit periodic L1-reference signal received power (“RSRP”) report(s) during the time duration indicated by drx-onDurationTimer in case DCP is configured but associated drx-onDurationTimer is not started.

When a DRX cycle is configured, the active time includes the time while:
drx-onDurationTimer or drx-InactivityTimer or drx-RetransmissionTimerDL or drx-RetransmissionTimerUL or ra-ContentionResolutionTimer is running; or
a scheduling request is sent on PUCCH and is pending; or
a PDCCH indicating a new transmission addressed to the C-RNTI of the MAC entity has not been received after successful reception of a random access response (“RAR”) for the random access preamble not selected by the MAC entity among the contention-based random access preamble.

When DRX is configured, the MAC entity shall:
if a MAC PDU is received in a configured downlink assignment:
   start the drx-HARQ-RTT-TimerDL for the corresponding HARQ process in the first symbol after the end of the corresponding transmission carrying the DL HARQ feedback;
   stop the drx-RetransmissionTimerDL for the corresponding HARQ process.
if a MAC PDU is transmitted in a configured uplink grant:
   start the drx-HARQ-RTT-TimerUL for the corresponding HARQ process in the first symbol after the end of the first repetition of the corresponding PUSCH transmission;
   stop the drx-RetransmissionTimerUL for the corresponding HARQ process.
if a drx-HARQ-RTT-TimerDL expires:
   if the data of the corresponding HARQ process was not successfully decoded:
      start the drx-RetransmissionTimerDL for the corresponding HARQ process in the first symbol after the expiry of drx-HARQ-RTT-TimerDL.
if a drx-HARQ-RTT-TimerUL expires:
   start the drx-RetransmissionTimerUL for the corresponding HARQ process in the first symbol after the expiry of drx-HARQ-RTT-TimerUL.
if a DRX Command MAC CE or a Long DRX Command MAC CE is received:
   stop drx-onDurationTimer;
   stop drx-InactivityTimer.
if drx-InactivityTimer expires or a DRX Command MAC CE is received:
   if the Short DRX cycle is configured:
      start or restart drx-ShortCycleTimer in the first symbol after the expiry of drx-InactivityTimer or in the first symbol after the end of DRX Command MAC CE reception;
      use the Short DRX Cycle.
   else:
      use the Long DRX cycle.
if drx-ShortCycleTimer expires:
   use the Long DRX cycle.
if a Long DRX Command MAC CE is received:
   stop drx-ShortCycleTimer;
   use the Long DRX cycle.
if the Short DRX Cycle is used, and [(SFN×10)+subframe number] modulo (drx-ShortCycle)=(drx-StartOffset) modulo (drx-ShortCycle):
   start drx-onDurationTimer after drx-SlotOffset from the beginning of the subframe.
if the Long DRX Cycle is used, and [(SFN×10)+subframe number] modulo (drx-LongCycle)=drx-StartOffset:
   if DCP is configured for the active DL BWP:
      if DCP indication associated with the current DRX Cycle received from lower layer indicated to start drx-onDurationTimer, e.g., as specified in TS 38.213; or
      if all DCP occasion(s) in time domain, e.g., as specified in TS 38.213, associated with the current DRX Cycle occurred in active time considering grants/assignments/DRX Command MAC CE/Long DRX Command MAC CE received and Scheduling Request sent until 4 ms prior to start of the last DCP occasion, or within bandwidth part (“BWP”) switching interruption length, or during a measurement gap; or
      if ps-Wakeup is configured with value true and DCP indication associated with the current DRX Cycle has not been received from lower layers:
         start drx-onDurationTimer after drx-SlotOffset from the beginning of the subframe.
   else:
      start drx-onDurationTimer after drx-SlotOffset from the beginning of the subframe.
NOTE 1: In case of unaligned system frame number (“SFN”) across carriers in a cell group, the SFN of the SpCell is used to calculate the DRX duration.
if the MAC entity is in active time:
   monitor the PDCCH, e.g., as specified in TS 38.213;
   if the PDCCH indicates a DL transmission:
      start the drx-HARQ-RTT-TimerDL for the corresponding HARQ process in the first symbol after the end of the corresponding transmission carrying the DL HARQ feedback, regardless of LBT failure indication from lower layers;
NOTE 2: When HARQ feedback is postponed by PDSCH-to-HARQ feedback timing indicating a non-numerical k1 value, e.g., as specified in TS 38.213, the corresponding transmission opportunity to send the DL HARQ feedback is indicated in a later PDCCH requesting the HARQ-ACK feedback.
   stop the drx-RetransmissionTimerDL for the corresponding HARQ process.
   if the PDSCH-to-HARQ_feedback timing indicate a non-numerical k1 value, e.g., as specified in TS 38.213:
      start the drx-RetransmissionTimerDL in the first symbol after the PDSCH transmission for the corresponding HARQ process.
   if the PDCCH indicates a UL transmission:
      start the drx-HARQ-RTT-TimerUL for the corresponding HARQ process in the first symbol after the end of the first repetition of the corresponding PUSCH transmission, regardless of LBT failure indication from lower layers;
      stop the drx-RetransmissionTimerUL for the corresponding HARQ process.
   if the PDCCH indicates a new transmission (DL or UL):
      start or restart drx-InactivityTimer in the first symbol after the end of the PDCCH reception.
if DCP is configured for the active DL BWP; and
if the current symbol n occurs within drx-onDurationTimer duration; and
if drx-onDurationTimer associated with the current DRX cycle is not started as specified in this clause; and
if the MAC entity would not be in active time considering grants/assignments/DRX Command MAC CE/Long DRX Command MAC CE received and Scheduling Request sent until 4 ms prior to symbol n when evaluating all DRX active time conditions as specified in this clause:
   not transmit periodic SRS and semi-persistent SRS, e.g., as defined in TS 38.214;
   not report semi-persistent CSI configured on PUSCH;
   if ps-Periodic_CSI_Transmit is not configured with value true:
      if ps-TransmitPeriodicL1-RSRP is not configured with value true:
         not report periodic CSI on PUCCH.
      else:
         not report periodic CSI on PUCCH, except L1-RSRP report(s).
else:
   in current symbol n, if the MAC entity would not be in active time considering grants/assignments/DRX Command MAC CE/Long DRX Command MAC CE received and Scheduling Request sent until 4 ms prior to symbol n when evaluating all DRX active time conditions as specified in this clause:
      not transmit periodic SRS and semi-persistent SRS, e.g., defined in TS 38.214;
      not report CSI on PUCCH and semi-persistent CSI configured on PUSCH.
   if CSI masking (csi-Mask) is setup by upper layers:
      in current symbol n, if drx-onDurationTimer would not be running considering grants/assignments/DRX Command MAC CE/Long DRX Command MAC CE received until 4 ms prior to symbol n when evaluating all DRX active time conditions as specified in this clause:
         not report CSI on PUCCH.
NOTE 3: If a UE multiplexes a CSI configured on PUCCH with other overlapping uplink control information (“UCI(s)”), e.g., according to the procedure specified in TS 38.213, and this CSI multiplexed with other UCI(s) would be reported on a PUCCH resource outside DRX active time, it is up to UE implementation whether to report this CSI multiplexed with other UCI(s).

Regardless of whether the MAC entity is monitoring PDCCH or not, the MAC entity transmits HARQ feedback, aperiodic CSI on PUSCH, and aperiodic SRS, e.g., defined in TS 38.214, when such is expected.

The MAC entity, in one embodiment, need not monitor the PDCCH if it is not a complete PDCCH occasion (e.g., the active time starts or ends in the middle of a PDCCH).

Regarding scheduling requests (“SR”), SR is used for requesting SL-SCH resources for new transmission when triggered by the sidelink buffer status reporting (“BSR”) or the SL-CSI reporting. If configured, the MAC entity performs the SR procedure.

The SR configuration of the logical channel that triggered the sidelink BSR (if such a configuration exists) is also considered as corresponding SR configuration for the triggered. The priority of the triggered SR corresponds to the priority of the logical channel.

If the SL-CSI reporting procedure is enabled by RRC, the SL-CSI reporting is mapped to zero or one SR configurations for all PC5-RRC connections established by RRC. The SR configuration of the SL-CSI reporting is considered as corresponding SR configuration for the triggered SR. The priority of the triggered SR corresponds to the priority of the SL-CSI reporting.

All pending SR(s) triggered according to the sidelink BSR procedure prior to the MAC PDU assembly shall be cancelled and each respective sr-ProhibitTimer shall be stopped when the MAC PDU is transmitted and the PDU includes a sidelink BSR MAC CE that contains buffer status up to (and including) the last event that triggered a sidelink BSR prior to the MAC PDU assembly.

All pending SR(s) triggered according to the sidelink BSR procedure may be cancelled and each respective sr-ProhibitTimer may be stopped when the SL grant(s) can accommodate all pending data available for transmission in sidelink.

The pending SR triggered according to the SL-CSI reporting may be cancelled and each respective sr-ProhibitTimer may be stopped when the SL grant(s) can accommodate all SL-CSI reporting(s) that have been triggered but not cancelled. All pending SR(s) triggered by either sidelink BSR or sidelink CSI report may be cancelled, when RRC configures autonomous resource selection.

In one embodiment, the assumption for some of the embodiments outlined in the following is that each SL LCH/SL service/SL application/SL destination is associated with a SL-DRX-configuration, which is e.g., defined as a combination of (offset_std_On-duration, On-duration-timer and periodicity). This SL DRX configuration may be, for example, (pre)configured/fixed in specifications. The SL On-duration starts at a fixed time offset (called offset_std_On-duration) from Time_0 based on a sync source from GNSS or gNB directly or indirectly from SLSS. On-duration-timer is restarted periodically with aperiodicity. It should be noted that the term SL “active time” may refer to the time period where a SL UE transmits and receives data/control on the PC5 interface. A predefined or configured destination-specific SL DRX pattern/configuration ensures that the SL data transmissions for a specific application/service/destination/LCH are synchronized between UE(s) interested in such service/application.

The Tx side of a UE, in one embodiment, is aware of when Rx UE(s) are “listening” for data of a specific SL LCH/application and the Rx side of UE knows when to monitor for SL data/control of a specific SL LCH/application. Such SL DRX pattern/configuration may also improve UE's power consumption, as a UE interested in a particular SL service/application needs only be “active” on the PC5 interface, e.g., monitor for SCI/PSSCH, at specific predefined/configured time periods. It may be also possible that a sidelink UE is using two separate DRX patterns/active times, e.g., one active time defining when the SL UE (e.g., Tx side) is allowed to transmit SL data/control on the PC5 interface to the peer UE(s) and another separate DRX pattern/active time determining when the same SL UE (e.g., Rx UE) is receiving SL data/control from the peer UE. It should be noted that the embodiments disclosed herein are equally applicable to both approaches, e.g., one “common” DRX pattern/active time per sidelink UE or two separate DRX pattern/active time per SL UE, e.g., one for Tx side and one for Rx side.

According to one embodiment, a Tx UE considers SL LCH(s) for the selection of the destination whose corresponding DRX active time respectively the DRX active time of the associated destination matches with the allocated SL resources, e.g., SL resources allocated by gNB or SL resources selected autonomously by the Tx UE (e.g., mode 2) are within the DRX active time of the SL LCH(s)/destination. For mode 1, for example, if the UE has SL data of SL LCH x in its buffer when a SL grant is received and the DRX active time associated with SL LCH x doesn't overlap with the SL resources (allocated by SL grant), e.g. SL LCH x is not in active time in the slot where SL resources are allocated, the UE shall not consider SL LCH x for the selection of the SL Destination and/or sidelink logical channel prioritization procedure. According to one implementation of the embodiment a new SL logical channel mapping restriction is introduced that is to be considered for the selection of the destination and/or the SL logical channel prioritization procedure to ensure that the selected destination is in drx active time for the allocated sidelink transmission resources.

According to a first implementation, the UE considers the SL logical channels for the selection of a destination associated to one of unicast, groupcast, and broadcast that satisfy the condition, in addition to other conditions, if configured, that the MAC entity/UE/destination is in active time according to the DRX configuration/status of the logical channel/destination in the slot(s)/symbol(s) in which the SL resources are allocated. In this implementation, the Tx UE is allowed to include data of a logical channel belonging to the selected destination in the transport block (“TB”) (according to the SL grant), which is not in active time for the SL grant. It should be noted that it may be possible that not all of the SL logical channels belonging to the selected destination are in active time.

One example of an embodiment of a sidelink logical channel prioritization procedure in the 3GPP specifications, e.g., TS 38.321, is described here that includes elements for the foregoing first implementation of the embodiment. In one embodiment, the sidelink logical channel prioritization procedure is applied when a new transmission is performed:
In one embodiment, RRC controls the scheduling of sidelink data by signaling for each logical channel:
   sl-Priority where an increasing priority value indicates a lower priority level;
   sl-PrioritisedBitRate, which sets the sidelink Prioritized Bit Rate (“sPBR”);
   sl-BucketSizeDuration, which sets the sidelink Bucket Size Duration (“sBSD”).
In one embodiment, RRC additionally controls the LCP procedure by configuring mapping restrictions for each logical channel:
   sl-configuredGrantTypelAllowed, which sets whether a configured grant Type 1 can be used for sidelink transmission;
   sl-AllowedCG-List, which sets the allowed configured grant(s) for sidelink transmission;
   sl-HARQ-FeedbackEnabled, which sets whether the logical channel is allowed to be multiplexed with logical channel(s) with sl-HARQ-FeedbackEnabled set to enabled or disabled.
In one embodiment, the following UE variable is used for the logical channel prioritization procedure:
   SBj, which is maintained for each logical channel.
The MAC entity shall initialize SBj of the logical channel to zero when the logical channel is established.
For each logical channel j, the MAC entity shall:
   increment SBj by the product sPBR×T before every instance of the LCP procedure, where T is the time elapsed since SBj was last incremented;
   if the value of SBj is greater than the sidelink bucket size (i.e., sPBR×sBSD):
      set SBj to the sidelink bucket size.
Note: The exact moment(s) when the UE updates SBj between LCP procedures is up to UE implementation, as long as SBj is up to date at the time when a grant is processed by LCP.
Regarding the selection of logical channels, in one embodiment, the MAC entity may, for each SCI corresponding to a new transmission:
   select a Destination associated to one of unicast, groupcast and broadcast, having at least one of the MAC CE and the logical channel with the highest priority, among the logical channels that satisfy all the following conditions and MAC CE(s), if any, for the SL grant associated to the SCI:
      SL data is available for transmission; and
      SBj>0, in case there is any logical channel having SBj>0; and
      sl-configuredGrantTypelAllowed, if configured, is set to true in case the SL grant is a Configured Grant Type 1; and
      sl-AllowedCG-List, if configured, includes the configured grant index associated to the SL grant; and
      sl-HARQ-FeedbackEnabled is set to disabled, if physical shared feedback channel (“PSFCH”) is not configured for the SL grant associated to the SCI; and
      SL DRX configuration/process of the logical channel is in active time for the SL grant associated to the SCI.
NOTE: If multiple destinations have the logical channels satisfying all conditions above with the same highest priority or if multiple destinations have either the MAC CE and/or the logical channels satisfying all conditions above with the same priority as the MAC CE, which destination is selected among them is up to UE implementation.
   select the logical channels satisfying all the following conditions among the logical channels belonging to the selected destination:
      SL data is available for transmission; and
      sl-configuredGrantType1Allowed, if configured, is set to true in case the SL grant is a Configured Grant Type 1; and
      SL DRX configuration/process of the logical channel is in active time for the SL grant associated to the SCI; and
      sl-AllowedCG-List, if configured, includes the configured grant index associated to the SL grant; and
         if PSFCH is configured for the sidelink grant associated to the SCI:
         sl-HARQ-FeedbackEnabled is set to enabled, if sl-HARQ-FeedbackEnabled is set to enabled for the highest priority logical channel satisfying the above conditions; or
         sl-HARQ-FeedbackEnabled is set to disabled, if sl-HARQ-FeedbackEnabled is set to disabled for the highest priority logical channel satisfying the above conditions.
         else:
         sl-HARQ-FeedbackEnabled is set to disabled.

In one embodiment, the LCH(s)/belonging to a destination need to be in active time.

According to a second implementation, a Tx UE considers SL LCH(s) for the selection of the destination and allocation of sidelink resources during the sidelink logical channel prioritization procedure whose corresponding DRX configuration respectively the DRX active time of the associated destination is in active time for the allocated SL resources. According to one implementation of the embodiment a SL logical channel mapping restriction is introduced, which is to be considered for the selection of the destination and the allocation of sidelink resources during the SL logical channel prioritization procedure. According to one implementation, the UE considers the logical channels for the selection of a destination and the allocation of sidelink resources that satisfy the condition that the SL DRX configuration/process of the logical channel/associated destination is in active time for the allocated SL resources. This implementation ensures that Tx UE transmits data of sidelink logical channels that are in active time respectively their associated destination is in active time for the allocated SL resources. Data of those logical channels belonging to the selected destination that are not in active time for the allocated SL resources are not considered for the TB generation, e.g., data of such LCHs cannot be multiplexed into a TB.

One example of an embodiment of a sidelink logical channel prioritization procedure in the 3GPP specifications, e.g., TS 38.321, is described here that includes elements for the foregoing first implementation of the embodiment. In one embodiment, the sidelink logical channel prioritization procedure is applied when a new transmission is performed:
In one embodiment, RRC controls the scheduling of sidelink data by signaling for each logical channel:
   sl-Priority where an increasing priority value indicates a lower priority level;
   sl-PrioritisedBitRate, which sets the sidelink Prioritized Bit Rate (“sPBR”);
   sl-BucketSizeDuration, which sets the sidelink Bucket Size Duration (“sBSD”).
In one embodiment, RRC additionally controls the LCP procedure by configuring mapping restrictions for each logical channel:
   sl-configuredGrantTypelAllowed, which sets whether a configured grant Type 1 can be used for sidelink transmission;
   sl-AllowedCG-List, which sets the allowed configured grant(s) for sidelink transmission;
   sl-HARQ-FeedbackEnabled, which sets whether the logical channel is allowed to be multiplexed with logical channel(s) with sl-HARQ-FeedbackEnabled set to enabled or disabled.
In one embodiment, the following UE variable is used for the logical channel prioritization procedure:
   SBj, which is maintained for each logical channel.
The MAC entity shall initialize SBj of the logical channel to zero when the logical channel is established.
For each logical channel j, the MAC entity shall:
   increment SBj by the product sPBR×T before every instance of the LCP procedure, where T is the time elapsed since SBj was last incremented;
   if the value of SBj is greater than the sidelink bucket size (i.e., sPBR×sBSD):
      set SBj to the sidelink bucket size.
Note: The exact moment(s) when the UE updates SBj between LCP procedures is up to UE implementation, as long as SBj is up to date at the time when a grant is processed by LCP.
Regarding the selection of logical channels, in one embodiment, the MAC entity may, for each SCI corresponding to a new transmission:
   select a Destination associated to one of unicast, groupcast and broadcast, having at least one of the MAC CE and the logical channel with the highest priority, among the logical channels that satisfy all the following conditions and MAC CE(s), if any, for the SL grant associated to the SCI:
      SL data is available for transmission; and
      SBj>0, in case there is any logical channel having SBj>0; and
      sl-configuredGrantTypelAllowed, if configured, is set to true in case the SL grant is a Configured Grant Type 1; and
      sl-AllowedCG-List, if configured, includes the configured grant index associated to the SL grant; and
      sl-HARQ-FeedbackEnabled is set to disabled, if physical shared feedback channel (“PSFCH”) is not configured for the SL grant associated to the SCI; and
      SL DRX configuration/process of the logical channel is in active time for the SL grant associated to the SCI.
NOTE: If multiple destinations have the logical channels satisfying all conditions above with the same highest priority or if multiple destinations have either the MAC CE and/or the logical channels satisfying all conditions above with the same priority as the MAC CE, which destination is selected among them is up to UE implementation.
   select the logical channels satisfying all the following conditions among the logical channels belonging to the selected destination:
      SL data is available for transmission; and
      sl-configuredGrantTypelAllowed, if configured, is set to true in case the SL grant is a Configured Grant Type 1; and
      SL DRX configuration/process of the logical channel is in active time for the SL grant associated to the SCI; and
      sl-AllowedCG-List, if configured, includes the configured grant index associated to the SL grant; and
         if PSFCH is configured for the sidelink grant associated to the SCI:
         sl-HARQ-FeedbackEnabled is set to enabled, if sl-HARQ-FeedbackEnabled is set to enabled for the highest priority logical channel satisfying the above conditions; or
         sl-HARQ-FeedbackEnabled is set to disabled, if sl-HARQ-FeedbackEnabled is set to disabled for the highest priority logical channel satisfying the above conditions.
         else:
         sl-HARQ-FeedbackEnabled is set to disabled.
      with equal priority should be served equally.
NOTE: The value of SBj can be negative.
In one embodiment, the UE may also follow the rules below during the SL scheduling procedures above:
   the UE should not segment an radio link control (“RLC”) service data unit (“SDU”) (or partially transmitted SDU or retransmitted RLC PDU) if the whole SDU (or partially transmitted SDU or retransmitted RLC PDU) fits into the remaining resources of the associated MAC entity;
   if the UE segments an RLC SDU from the logical channel, it shall maximize the size of the segment to fill the grant of the associated MAC entity as much as possible;
   the UE should maximize the transmission of data;
   if the MAC entity is given a sidelink grant size that is equal to or larger than 12 bytes while having data available and allowed for transmission, the MAC entity shall not transmit only padding;
   a logical channel configured with sl-HARQ-FeedbackEnabled set to enabled and a logical channel configured with sl-HARQ-FeedbackEnabled set to disabled cannot be multiplexed into the same MAC PDU.
In one embodiment, the MAC entity does not generate a MAC PDU for the HARQ entity if the following conditions are satisfied:
   there is no Sidelink CSI Reporting MAC CE generated for this PSSCH transmission; and
   the MAC PDU includes zero MAC SDUs.
In one embodiment, logical channels are prioritised in accordance with the following order (highest priority listed first):
   data from sidelink control channel (“SCCH”);
   sidelink CSI Reporting MAC CE;
   data from any sidelink traffic channel (“STCH”).

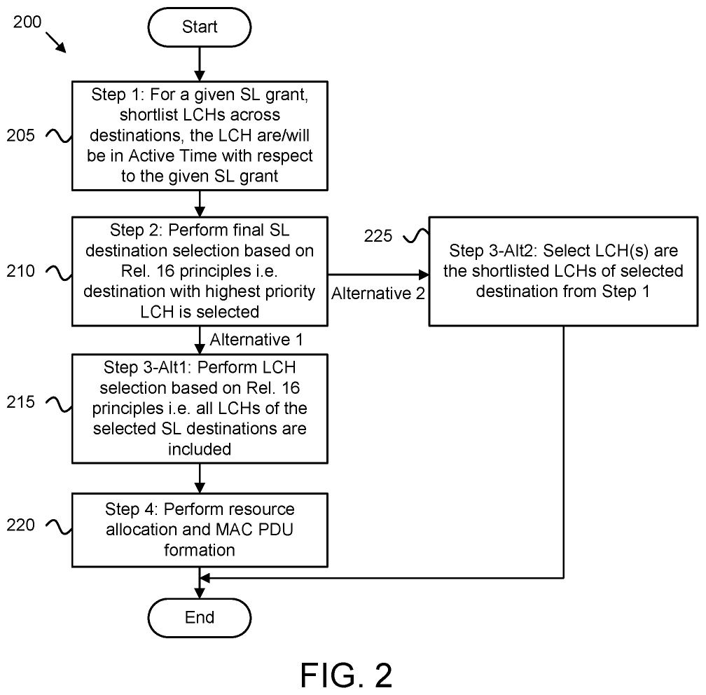

FIG. 2 is a flowchart diagram 200 depicting one embodiment of UE behavior as well as a SL logical channel prioritization procedure. In one embodiment, alternative 1 describes the embodiment where the Tx UE considers the LCHs belonging to the selected destination regardless of whether the sidelink logical channel is in active time for the SL grant or not. Alternative 2, in one embodiment, describes the embodiment where the Tx UE considers the SL LCHs for SL resource allocation that are in active time for the SL grant.

According to one embodiment, the Tx UE considers SL LCH(s) for the selection of the destination and subsequently for the allocation of sidelink resources during the sidelink logical channel prioritization procedure that has a corresponding DRX configuration is in active time for the allocated SL resources. According to one implementation of the embodiment, a SL logical channel mapping restriction is introduced that is considered for the selection of the destination and also for the allocation of sidelink resources during the SL logical channel prioritization procedure. Data of those logical channels belonging to the selected destination that are not in active time for the allocated SL resources are considered for the TB generation for cases when there are some remaining resources after data of the LCHs that are in active time has been multiplexed in the TB. In order to avoid the inclusion of padding in the SL TB, the UE multiplexes data of logical channels belonging to the selected destination that are not in active time for the allocated SL resources/SL grant. However, the data of LCHs that are in active time is prioritized over the data of the LCHs that are not in active time, e.g., data of LCHs that are in active time are multiplexed first into the TB corresponding to the allocated SL resources.

As shown in FIG. 2, at step 1, the method 200, for a given SL grant, shortlists 205 LCHs across destinations. In such an embodiment, the LCHs are or will be in active time with respect to the given SL grant. At step 2, in one embodiment, the method 200 performs 210 final SL destination selection based on Rel. 16 principles such as selecting a destination with the highest priority LCH. At step 3-alternative 1, in one embodiment, the method 200 performs 215 LCH selection based on Rel. 16 principles such as selecting LCHs of the selected SL destination. At step 4, in one embodiment, the method 200 performs 220 resource allocation and MAC PDU formation, and the method 200 ends. According to alternative 2, at step 3, the method 200 selects 225 LCHs that are shortlisted from the selected destination in step 1, and the method 200 ends.

Regarding handling of SL-drxInactivityTimer, in one embodiment, a SL UE maintains a SL-drxInactivityTimer per logical channel/PQI. A SL transmitting UE may according to one implementation of the embodiment start the SL-drxInactivityTimer at the slot following an SCI (re)transmission. In one example, a Tx UE starts the SL-drxInactivityTimer for each of the logical channel(s)/PQI(s) that belong to the destination indicated within the SCI. An assumption for this embodiment is that that UE has DRX configuration/process per sidelink logical channel or per PQI. Similarly, a RX UE maintains a SL-drxInactivityTimer per (sidelink) logical channel or per PQI. In one example, a Rx UE starts the SL-drxInactitiyTimer for each of the logical channels/PQIs belonging to the destination indicated within the SCI upon reception of a SCI, e.g., in the symbol/slot after reception of the second stage SCI. It should be noted that the value of the SL-drxInactivityTimer may be configured per pair of source/destination Layer IDs, whereas a SL-drxInactitiyTimer is maintained per logical channel/PQI because a DRX configuration is (pre)configured per logical channel/PQI.

It should be noted that the above described embodiments are applicable to various cast types, e.g., unicast, groupcast, and/or broadcast as well as to various sidelink resource allocation modes, e.g., mode 1 (gNB controlled resource allocation), mode 2 (UE autonomous resource allocation mode), and/or a mixture of mode 1 and mode 2.

Regarding SL resource selection in mode 2 considering DRX, in one embodiment, a TX UE considers the DRX configuration(s) of the logical channels/destinations, e.g., LCHs included in a TB, during the SL resources (re)selection procedure, e.g., mode 2 resource allocation mode. A Tx UE, in one embodiment, selects in mode 2 autonomously new SL resources when it generates a new TB. A new selection may also be triggered because a new TB does not fit in the previously reserved resources. To select new SL resources (for both dynamic and semi-persistent schemes), in one embodiment, a UE first defines the selection window where it looks for candidate resources to transmit a TB. According to one implementation of the embodiment, a UE excludes all candidate SL resources, e.g., within the selection window, which are not part of the active time of the DRX configuration(s) associated with the logical channels' destination included in a TB. The motivation for this embodiment is to ensure that SL resources are selected during the SL transmission resource (re)selection procedure for a TB that falls into the active time of the logical channel(s) included in the TB respectively the active time of the destination.

The selection window, in one embodiment, includes resources within the range of slots [n+T1, n+T2], where n is the resource (re-)selection trigger or slot at which new resources must be selected. In one embodiment, T1 is the processing time (in slots) for a UE to identify candidate resources and select new SL resources for transmission. In one embodiment, T1 is equal to or smaller than Tproc,1. In one embodiment, the value of T2 is left to UE implementation but is included within the range T2min≤T2≤PDB, where PDB is the packet delay budget (in slots). PDB, in one embodiment, is the latency deadline by which the TB is transmitted.

Once the selection window is defined, in one embodiment, the UE identifies the candidate resources within the selection window. As an additional step during the SL resource (re)selection procedure, in one embodiment, the TX UE also considers the DRX configuration(s) of the LCH(s)/PQI(s)/destination included in a TB. In one example, the Tx UE excludes candidate resources in the selection window that don't fall into the active time of the LCH(s)/PQI(s) included in a TB. In one example, the Tx UE does not consider DRX configuration(s) of the LCH(s)/PQI(s)/destination during the sidelink LCP procedure as described in above embodiments, but considers the DRX configuration(s) during the SL resource (re)selection procedure for the mode 2 resource allocation mode.

According to one embodiment, a Tx UE triggers a SL resource reselection procedure for instances when the selected SL resources for a TB don't fall within the active time of the LCH(s)/PQI(s) included in the TB respectively the active time of the destination(s). In one embodiment, the SL resource that was initially selected by the UE doesn't fall within the active time of the LCHs/PQI included in a TB because the DRX status has been updated after the initial SL resource selection. In such an embodiment, the Tx UE selects another SL resource for the transmission of the TB to ensure that the Rx UE(s) are awake and ready for reception.

In one embodiment, the sidelink transmitter UE behaves according to Rel. 16 principles for destination selection, logical channel selection, and resource allocation but additionally selects a DRX configuration among the DRX configurations from the corresponding included LCHs that provide the longest time opportunity for transmission towards the selected destination if the UE buffer has sufficient data to be the transmitter for this destination. If, however, the UE buffer does not have sufficient data to be the transmitter for this destination (after the current transmission), the UE selects a DRX configuration among the DRX configurations from the corresponding included LCHs that provides the earliest time opportunity for entering DRX sleep with respect to the given destination.

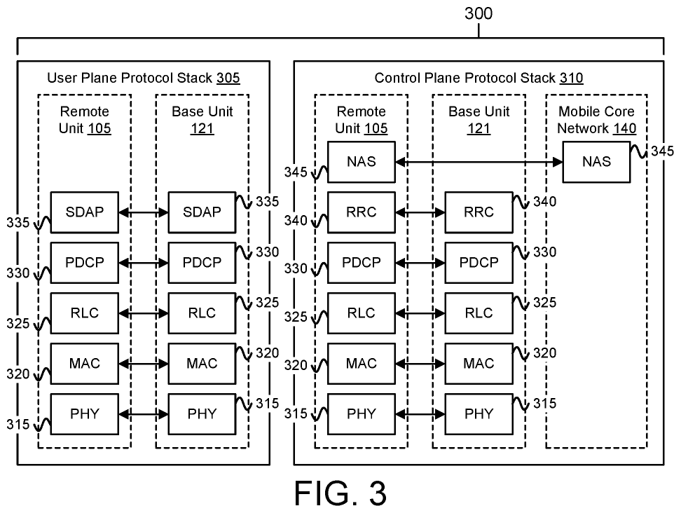

FIG. 3 depicts a NR protocol stack 300, according to embodiments of the disclosure. While FIG. 3 shows the remote unit 105, the base unit 121 and the mobile core network 130, these are representative of a set of UEs interacting with a RAN node and a NF (e.g., AMF) in a core network. As depicted, the protocol stack 300 comprises a User Plane protocol stack 305 and a Control Plane protocol stack 310. The User Plane protocol stack 305 includes a physical (“PHY”) layer 315, a Medium Access Control (“MAC”) sublayer 320, a Radio Link Control (“RLC”) sublayer 325, a Packet Data Convergence Protocol (“PDCP”) sublayer 330, and Service Data Adaptation Protocol (“SDAP”) layer 335. The Control Plane protocol stack 310 also includes a physical layer 315, a MAC sublayer 320, a RLC sublayer 325, and a PDCP sublayer 330. The Control Place protocol stack 310 also includes a Radio Resource Control (“RRC”) layer and a Non-Access Stratum (“NAS”) layer 345.

The AS protocol stack for the Control Plane protocol stack 310 consists of at least RRC, PDCP, RLC and MAC sublayers, and the physical layer. The AS protocol stack for the User Plane protocol stack 305 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 340 and the NAS layer 345 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 315 offers transport channels to the MAC sublayer 320. The MAC sublayer 320 offers logical channels to the RLC sublayer 325. The RLC sublayer 325 offers RLC channels to the PDCP sublayer 330. The PDCP sublayer 330 offers radio bearers to the SDAP sublayer 335 and/or RRC layer 340. The SDAP sublayer 335 offers QoS flows to the mobile core network 130 (e.g., 5GC). The RRC layer 340 provides for the addition, modification, and release of Carrier Aggregation and/or Dual Connectivity. The RRC layer 340 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

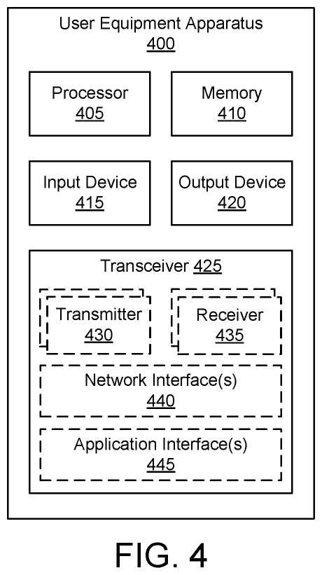

FIG. 4 depicts a user equipment apparatus 400 that may be used for sidelink logical channel prioritization, according to embodiments of the disclosure. In various embodiments, the user equipment apparatus 400 is used to implement one or more of the solutions described above. The user equipment apparatus 400 may be one embodiment of a UE, such as the remote unit 105 and/or the UE 205, as described above. Furthermore, the user equipment apparatus 400 may include a processor 405, a memory 410, an input device 415, an output device 420, and a transceiver 425. In some embodiments, the input device 415 and the output device 420 are combined into a single device, such as a touchscreen. In certain embodiments, the user equipment apparatus 400 may not include any input device 415 and/or output device 420. In various embodiments, the user equipment apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more base units 121. Additionally, the transceiver 425 may support at least one network interface 440 and/or application interface 445. The application interface(s) 445 may support one or more APIs. The network interface(s) 440 may support 3GPP reference points, such as Uu and PC5. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and operating system (“OS”) functions and a baseband processor (also known as “baseband radio processor”) which manages radio functions.

In various embodiments, the processor 405 controls the user equipment apparatus 400 to implement the above described UE behaviors for sidelink logical channel prioritization.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to CSI enhancements for higher frequencies. For example, the memory 410 may store parameters, configurations, resource assignments, policies, and the like as described above. In certain embodiments, the memory 410 also stores program code and related data, such as an operating system or other controller algorithms operating on the user equipment apparatus 400, and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, the output device 420 may be located near the input device 415.

The transceiver 425 includes at least transmitter 430 and at least one receiver 435. The transceiver 425 may be used to provide UL communication signals to a base unit 121 and to receive DL communication signals from the base unit 121, as described herein. Similarly, the transceiver 425 may be used to transmit and receive SL signals (e.g., V2X communication), as described herein. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an ASIC, or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

In one embodiment, the processor 405 determines a sidelink (“SL”) grant for a new SL transmission and selects a destination for the new SL transmission allocated by the SL grant based on at least one of a set of SL logical channels (“LCHs”) and a set of medium access control (“MAC”) control elements (“CEs”). In one embodiment, the selected destination is in a SL active time for a SL transmission occasion allocated by the SL grant for the new SL transmission.

In one embodiment, the set of SL LCHs comprises SL LCHs with an associated destination that is in SL active time for the SL transmission occasion allocated by the SL grant.

In one embodiment, the processor 405 further selects a SL LCH for the selection of the destination that has discontinuous reception (“DRX”) active time that matches allocated SL resources for the SL grant.

In one embodiment, the DRX active time of the destination matches the allocated SL resources in response to the DRX active time for the SL LCH of the destination overlapping with the allocated SL resources.

In one embodiment, the processor 405 further selects the set of SL LCHs for the selection of the destination considering a SL LCH mapping restriction configured for a SL LCH.

In one embodiment, the processor 405 selects the destination for the SL transmission associated with one of a unicast transmission, a groupcast transmission, and a broadcast transmission that is in the SL active time according to a discontinuous reception (“DRX”) configuration of the destination in the slot/symbol in which SL resources are allocated by the SL grant.

In one embodiment, the processor 405 includes data of SL LCHs associated with the selected destination in a transport block (“TB”) that are not in active time for the SL transmission resources allocated by the SL grant.

In one embodiment, the processor 405 ignores data of SL LCHs associated with the destination that are not in active time for allocated SL resources.

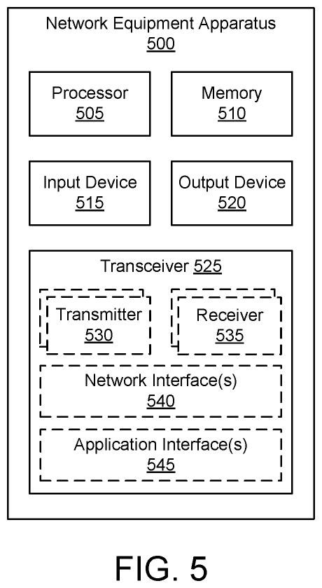

FIG. 5 depicts one embodiment of a network apparatus 500 that may be used for sidelink logical channel prioritization, according to embodiments of the disclosure. In some embodiments, the network apparatus 500 may be one embodiment of a RAN node and its supporting hardware, such as the base unit 121 and/or gNB, described above. Furthermore, network apparatus 500 may include a processor 505, a memory 510, an input device 515, an output device 520, and a transceiver 525. In certain embodiments, the network apparatus 500 does not include any input device 515 and/or output device 520.

As depicted, the transceiver 525 includes at least one transmitter 530 and at least one receiver 535. Here, the transceiver 525 communicates with one or more remote units 105. Additionally, the transceiver 525 may support at least one network interface 540 and/or application interface 545. The application interface(s) 545 may support one or more APIs. The network interface(s) 540 may support 3GPP reference points, such as Uu, N1, N2, N3, N5, N6 and/or N7 interfaces. Other network interfaces 540 may be supported, as understood by one of ordinary skill in the art.

When implementing an NEF, the network interface(s) 540 may include an interface for communicating with an application function (i.e., N5) and with at least one network function (e.g., UDR, SFC function, UPF) in a mobile communication network, such as the mobile core network 130.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and operating system (“OS”) functions and a baseband processor (also known as “baseband radio processor”) which manages radio function. In various embodiments, the processor 505 controls the network apparatus 500 to implement the above described network entity behaviors (e.g., of the gNB) for sidelink logical channel prioritization.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data relating to CSI enhancements for higher frequencies. For example, the memory 510 may store parameters, configurations, resource assignments, policies, and the like as described above. In certain embodiments, the memory 510 also stores program code and related data, such as an operating system (“OS”) or other controller algorithms operating on the network apparatus 500, and one or more software applications.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, may include any known electronically controllable display or display device. The output device 520 may be designed to output visual, audible, and/or haptic signals. In some embodiments, the output device 520 includes an electronic display capable of outputting visual data to a user. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, all or portions of the output device 520 may be located near the input device 515.

As discussed above, the transceiver 525 may communicate with one or more remote units and/or with one or more interworking functions that provide access to one or more PLMNs. The transceiver 525 may also communicate with one or more network functions (e.g., in the mobile core network 80). The transceiver 525 operates under the control of the processor 505 to transmit messages, data, and other signals and also to receive messages, data, and other signals. For example, the processor 505 may selectively activate the transceiver (or portions thereof) at particular times in order to send and receive messages.

The transceiver 525 may include one or more transmitters 530 and one or more receivers 535. In certain embodiments, the one or more transmitters 530 and/or the one or more receivers 535 may share transceiver hardware and/or circuitry. For example, the one or more transmitters 530 and/or the one or more receivers 535 may share antenna(s), antenna tuner(s), amplifier(s), filter(s), oscillator(s), mixer(s), modulator/demodulator(s), power supply, and the like. In one embodiment, the transceiver 525 implements multiple logical transceivers using different communication protocols or protocol stacks, while using common physical hardware.

In one embodiment, the processor 505 applies discontinuous reception (“DRX”) for sidelink (“SL”) transmission with a user equipment (“UE”) and enables an SL active time state for the SL transmission over an SL logical channel (“LCH”). In one embodiment, the transceiver 525 receives the SL transmission from the transmitting UE over the SL LCH in response to applying DRX and enabling the SL active time state.

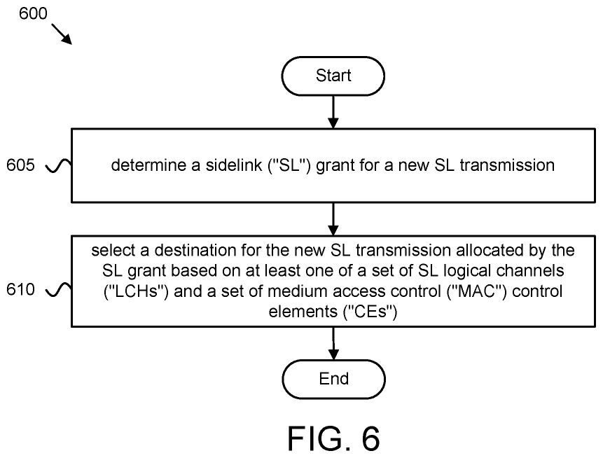

FIG. 6 is a flowchart diagram of a method 600 for sidelink logical channel prioritization. The method 600 may be performed by a UE as described herein, for example, the remote unit 105 and/or the user equipment apparatus 400. In some embodiments, the method 600 may be performed by a processor executing program code, for example, a microcontroller, a microprocessor, a CPU, a GPU, an auxiliary processing unit, a FPGA, or the like.

In one embodiment, the method 600 determines 605 a sidelink (“SL”) grant for a new SL transmission. In one embodiment, the method 600 selects 610 a destination for the new SL transmission allocated by the SL grant based on at least one of a set of SL logical channels (“LCHs”) and a set of medium access control (“MAC”) control elements (“CEs”). In one embodiment, the selected destination is in a SL active time for a SL transmission occasion allocated by the SL grant for the new SL transmission. The method 600 ends.

A first apparatus is disclosed for sidelink logical channel prioritization. In one embodiment, the first apparatus may be performed by a UE as described herein, for example, the remote unit 105 and/or the user equipment apparatus 400. In some embodiments, the first apparatus may be performed by a processor executing program code, for example, a microcontroller, a microprocessor, a CPU, a GPU, an auxiliary processing unit, a FPGA, or the like.

In one embodiment, the first apparatus includes a processor that determines a sidelink (“SL”) grant for a new SL transmission and selects a destination for the new SL transmission allocated by the SL grant based on at least one of a set of SL logical channels (“LCHs”) and a set of medium access control (“MAC”) control elements (“CEs”). In one embodiment, the selected destination is in a SL active time for a SL transmission occasion allocated by the SL grant for the new SL transmission.

In one embodiment, the set of SL LCHs comprises SL LCHs with an associated destination that is in SL active time for the SL transmission occasion allocated by the SL grant.

In one embodiment, the processor further selects a SL LCH for the selection of the destination that has discontinuous reception (“DRX”) active time that matches allocated SL resources for the SL grant.

In one embodiment, the DRX active time of the destination matches the allocated SL resources in response to the DRX active time for the SL LCH of the destination overlapping with the allocated SL resources.

In one embodiment, the processor further selects the set of SL LCHs for the selection of the destination considering a SL LCH mapping restriction configured for a SL LCH.

In one embodiment, the processor selects the destination for the SL transmission associated with one of a unicast transmission, a groupcast transmission, and a broadcast transmission that is in the SL active time according to a discontinuous reception (“DRX”) configuration of the destination in the slot/symbol in which SL resources are allocated by the SL grant.

In one embodiment, the processor includes data of SL LCHs associated with the selected destination in a transport block (“TB”) that are not in active time for the SL transmission resources allocated by the SL grant.

In one embodiment, the processor ignores data of SL LCHs associated with the destination that are not in active time for allocated SL resources.

A first method is disclosed for sidelink logical channel prioritization. In one embodiment, the first method may be performed by a UE as described herein, for example, the remote unit 105 and/or the user equipment apparatus 400. In some embodiments, the first method may be performed by a processor executing program code, for example, a microcontroller, a microprocessor, a CPU, a GPU, an auxiliary processing unit, a FPGA, or the like.

In one embodiment, the first method determines a sidelink (“SL”) grant for a new SL transmission and selects a destination for the new SL transmission allocated by the SL grant based on at least one of a set of SL logical channels (“LCHs”) and a set of medium access control (“MAC”) control elements (“CEs”). In one embodiment, the selected destination is in a SL active time for a SL transmission occasion allocated by the SL grant for the new SL transmission.

In one embodiment, the set of SL LCHs comprises SL LCHs with an associated destination that is in SL active time for the SL transmission occasion allocated by the SL grant.

In one embodiment, the first method further selects a SL LCH for the selection of the destination that has discontinuous reception (“DRX”) active time that matches allocated SL resources for the SL grant.

In one embodiment, the DRX active time of the destination matches the allocated SL resources in response to the DRX active time for the SL LCH of the destination overlapping with the allocated SL resources.

In one embodiment, the first method further selects the set of SL LCHs for the selection of the destination considering a SL LCH mapping restriction configured for a SL LCH.

In one embodiment, the first method selects the destination for the SL transmission associated with one of a unicast transmission, a groupcast transmission, and a broadcast transmission that is in the SL active time according to a discontinuous reception (“DRX”) configuration of the destination in the slot/symbol in which SL resources are allocated by the SL grant.

In one embodiment, the first method includes data of SL LCHs associated with the selected destination in a transport block (“TB”) that are not in active time for the SL transmission resources allocated by the SL grant.

In one embodiment, the first method ignores data of SL LCHs associated with the destination that are not in active time for allocated SL resources.

A second apparatus is disclosed for sidelink logical channel prioritization. In one embodiment, the second apparatus may be performed by a network device as described herein, for example, the base unit 121 and/or the network equipment apparatus 500. In some embodiments, the second apparatus may be performed by a processor executing program code, for example, a microcontroller, a microprocessor, a CPU, a GPU, an auxiliary processing unit, a FPGA, or the like.

In one embodiment, the second apparatus includes a processor that applies discontinuous reception (“DRX”) for sidelink (“SL”) transmission with a user equipment (“UE”) and enables an SL active time state for the SL transmission over an SL logical channel (“LCH”). In one embodiment, the second apparatus includes a transceiver that receives the SL transmission from the transmitting UE over the SL LCH in response to applying DRX and enabling the SL active time state.

A second method is disclosed for sidelink logical channel prioritization. In one embodiment, the second method may be performed by a network device as described herein, for example, the base unit 121 and/or the network equipment apparatus 500. In some embodiments, the second method may be performed by a processor executing program code, for example, a microcontroller, a microprocessor, a CPU, a GPU, an auxiliary processing unit, a FPGA, or the like.

In one embodiment, the second method applies discontinuous reception (“DRX”) for sidelink (“SL”) transmission with a user equipment (“UE”), enables an SL active time state for the SL transmission over an SL logical channel (“LCH”), and receives the SL transmission from the transmitting UE over the SL LCH in response to applying DRX and enabling the SL active time state.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a processor that:
determines a sidelink (“SL”) grant for a new SL transmission; and
selects a destination for the new SL transmission allocated by the SL grant based on at least one of a set of SL logical channels (“LCHs”) and a set of medium access control (“MAC”) control elements (“CEs”),
wherein the selected destination is in a SL active time for a SL transmission occasion allocated by the SL grant for the new SL transmission.

2. The apparatus of claim 1, wherein the set of SL LCHs comprises SL LCHs with an associated destination that is in SL active time for the SL transmission occasion allocated by the SL grant.

3. The apparatus of claim 1, wherein the processor further selects a SL LCH for the selection of the destination that has a discontinuous reception (“DRX”) active time that matches allocated SL resources for the SL grant.

4. The apparatus of claim 3, wherein the DRX active time of the destination matches the allocated SL resources in response to the DRX active time for the SL LCH of the destination overlapping with the allocated SL resources.

5. The apparatus of claim 1, wherein the processor further selects the set of SL LCHs for the selection of the destination considering a SL LCH mapping restriction configured for a SL LCH.

6. The apparatus of claim 1, wherein the processor selects the destination for the SL transmission associated with one of a unicast transmission, a groupcast transmission, and a broadcast transmission that is in the SL active time according to a discontinuous reception (“DRX”) configuration of the destination in the slot/symbol in which SL resources are allocated by the SL grant.

7. The apparatus of claim 1, wherein the processor includes data of SL LCHs associated with the selected destination in a transport block (“TB”) that are not in active time for the SL transmission resources allocated by the SL grant.

8. The apparatus of claim 1, wherein the processor ignores data of SL LCHs associated with the destination that are not in active time for allocated SL resources.

9. A method, comprising:
determining a sidelink (“SL”) grant for a new SL transmission; and
selecting a destination for the new SL transmission allocated by the SL grant based on at least one of a set of SL logical channels (“LCHs”) and a set of medium access control (“MAC”) control elements (“CEs”),
wherein the selected destination is in a SL active time for a SL transmission occasion allocated by the SL grant for the new SL transmission.

10. The method of claim 9, wherein the set of SL LCHs comprises SL LCHs with an associated destination that is in SL active time for the SL transmission occasion allocated by the SL grant.

11. The method of claim 9, further comprising selecting a SL LCH for the selection of the destination that has discontinuous reception (“DRX”) active time that matches allocated SL resources for the SL grant.

12. The method of claim 11, wherein the DRX active time of the destination matches the allocated SL resources in response to the DRX active time for the SL LCH of the destination overlapping with the allocated SL resources.

13. The method of claim 9, further comprising selecting the set of SL LCHs for the selection of the destination considering a SL LCH mapping restriction configured for a SL LCH.

14. The method of claim 9, further comprising selecting the destination for the SL transmission associated with one of a unicast transmission, a groupcast transmission, and a broadcast transmission that is in the SL active time according to a discontinuous reception (“DRX”) configuration of the destination in the slot/symbol in which SL resources are allocated by the SL grant.

15. An apparatus, comprising:
a processor that:
applies discontinuous reception (“DRX”) for sidelink (“SL”) transmission with a user equipment (“UE”); and
enables an SL active time state for the SL transmission over an SL logical channel (“LCH”); and
a transceiver that receives the SL transmission from the transmitting UE over the SL LCH in response to applying DRX and enabling the SL active time state.
